(19) United States
(12) Patent Application Publication
(10) Pub. No.: US 2020/0311649 A1
(43) Pub. Date: Oct. 1, 2020

(54) SYSTEM AND METHOD FOR LOCATION BASED COOKING PAIRING

(71) Applicant: Iqbal Singh Dhaliwal, Kamloops (CA)

(72) Inventor: Iqbal Singh Dhaliwal, Kamloops (CA)

(21) Appl. No.: 16/371,081

(22) Filed: Mar. 31, 2019

(51) Int. Cl. G06Q 10/06; G06Q 50/12; G06Q 30/06

(52) U.S. Cl. CPC G06Q 10/063112; G06Q 30/0627; G06Q 30/0611; G06Q 50/12

(57) ABSTRACT

Methods and systems for the matching a consumer with a chef. Candidate chefs are identified for a meal request based on meal request data, chef data and consumer data. A communication network interface is configured to receive the meal request from the consumer, provide the meal request to at least one candidate chef, receive acceptance of the meal request from at least one candidate chef and to provide the consumer with an identification of the at least one accepted candidate chef. The methods and systems are further configured to provide for the transfer payment from a consumer account to a chef account.

### REFERENCE TO PENDING APPLICATIONS

This application does not claim the benefit of any issued U.S. Patent or pending application.

### BACKGROUND OF THE INVENTION

### Field of the Invention

The present invention generally relates to the dining experience, and in particular to systems and methods to associate consumers with a chef that matches a set of criteria.

### Background

In today's society, people enjoy eating ethnic cuisine. This is due, at least in part, to people experiencing ethnic cuisine by travelling to different countries or having an interest in that cuisine. For example, an immigrant from India who has relocated into another country may enjoy eating authentic Indian cuisine.

However, restaurants in other countries may not necessarily create authentic ethnic cuisine due to various reasons and factors such as the cost of ingredients and the expectations by their customer base. As such, many restaurants modify authentic ethnic cuisine into a modified type of cuisine. An example of a modified cuisine is the Tex-Mex cuisine, which combines Mexican cuisine that has been modified with ingredients found in Texas.

Additionally, there is a growing desire and need to provide meals on a delivery basis as the cost of transportation and eating at a restaurant is increasing. Further, there is a desire to provide a meal that utilizes authentic ethnic ingredients.

Further, people enjoy sharing a meal with family and friends which can include the preparation of that meal. As such, there is a desire to share an ethnic meal where family and friends can participate in the preparation thereof.

Accordingly, there is a need for a service which can satisfy the need set out above.

### BRIEF SUMMARY OF THE INVENTION

According to an aspect of the present invention, there are methods and systems for matching a consumer with a chef.

In one aspect, a system for matching a consumer with a chef includes a chef module configured to receive and store chef data, a consumer module configured to receive and store consumer data and a cuisine matching server configured to receive a meal request from a consumer. This aspect identifies a candidate chef for the meal request based on the meal request data, chef data, consumer data. Further this aspect provides for the transfer payment from a consumer account to a chef account. A communication network interface is configured to receive the meal request from the consumer, provide the meal request to at least one candidate chef, receive acceptance of the meal request from at least one candidate chef, and to provide the consumer with an identification of the at least one accepted candidate chef.

In some aspects, the chef data includes the chef's name, address, cooking experience and cooking cuisine preferences, and the consumer data includes the consumer's name, address and ethnic cuisine preferences. The meal request data includes ethnic food preference, date of meal, time of meal, and number of people to be served.

In some aspects, the system further includes a rating module configured to receive and store chef performance rating data by one or more consumers and consumer rating data by one or more chefs. The rating data may be included in the data used by the consumer and chef.

In some aspects, a method for matching a consumer with a chef include receiving a meal request from the consumer, providing the meal request to at least one candidate chef, receiving an acceptance of the meal request from at least one candidate chef and providing the consumer with an identification of the at least one accepted candidate chef.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a schematic block diagram of a system in accordance with embodiments of the present invention.

FIG. 2 is a block diagram of a data processing system implementing a cuisine matching server in accordance with embodiments of the present invention.

FIG. 3 is a detailed block diagram of a data processing system implementing a cuisine matching server in accordance with embodiments of the present invention.

FIG. 4 is flowchart illustrating operations for matching a consumer with a chef in accordance with embodiments of the present invention.

FIG. 5 is flowchart illustrating operations for matching a consumer with a chef in accordance with embodiments of the present invention.

### DETAILED DESCRIPTION OF THE INVENTION

The present invention is directed toward a system that creates the availability for the preparation of an ethnically-based meal that utilizes authentic ethnic ingredients, while provide for the sharing of the preparation of the meal with family and friends.

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer-usable program code means embodied in the medium. Any suitable computer readable medium may be used including hard disks, CD-ROMs, optical storage devices, a transmission media such as those supporting the Internet or an intranet, or magnetic storage devices.

Computer program code for carrying out operations of the present invention may be written in an object oriented programming language, such as Java® or C++. However, the computer program code for carrying out operations of the present invention may also be written in conventional procedural programming languages, such as the “C” programming language or assembly language. The program code may execute entirely on the user's computer, partly on the user's computer, as a stand alone software package, partly on the user's computer and partly on a remote computer, or entirely on the remote computer. In the latter scenario, the remote computer may be connected to the user's computer through a local area network (LAN) or a wide area network (WAN).

The present invention is described below with reference to flowchart illustrations and/or block diagrams of methods, apparatus (systems) and computer program products according to some embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

Embodiments of the present invention will now be described with respect to the figures. Embodiments of the present invention provide methods, systems and/or computer program products for matching a consumer with a chef in the preparation of a meal at the consumer's location. For purposes of this disclosure, the term chef refers to anyone who prepares food ranging from persons who are professionally trained and work in a professional setting to persons who primarily prepare food at home and who are not professionally trained nor work in the food preparation industry.

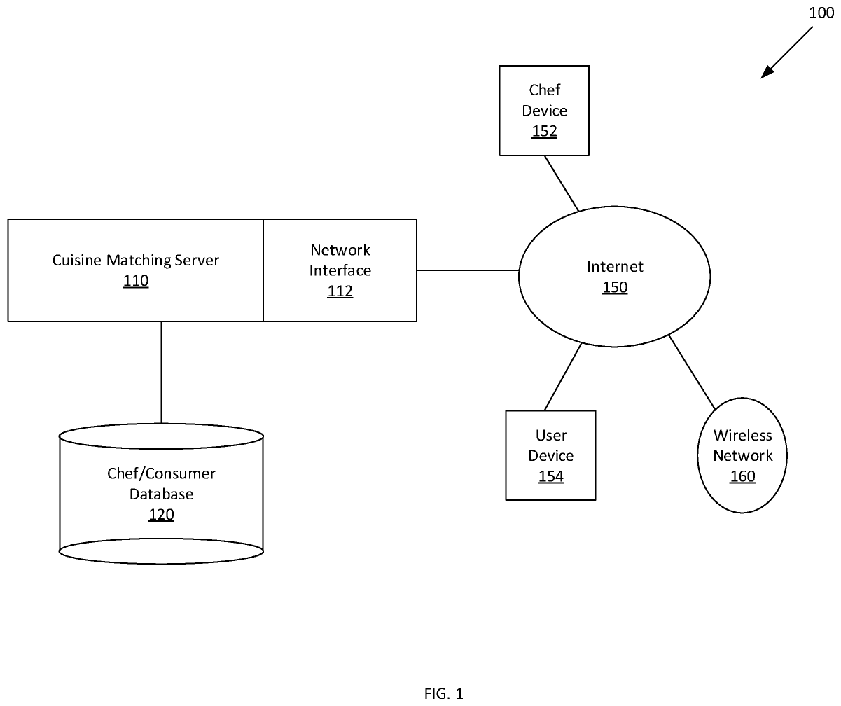

Referring first to FIG. 1, a hardware and software environment including embodiments of the present invention will be described. As shown in FIG. 1, a cuisine matching server 110 is coupled through a network interface 112 to a network 150, such as an internet network. The cuisine matching server 110 is further operatively coupled to a chef/consumer data base 120. The cuisine matching server 110 is configured to identify a candidate chef for preparation of a meal as requested by a consumer based on the meal preferences of the consumer. The chef/consumer database 120 contains information related to chefs, consumers or both. The chef/consumer database 120 may contain additional information in various embodiments of the present invention, such as availability information for the chefs stating times and dates on which they are available for providing meal services responsive to consumer requests for a meal. Thus, a cuisine matching server 110 may be configured to identify a candidate chef based on a variety of information including, but not limited to, the location of a consumer, the location of the chef, the experience of the chef, the price range acceptable to the chef, whether the preparation of the meal is to be on-site, i.e. at the consumer's location, or off-site and brought to the consumer's location.

The network interface 112, as shown in FIG. 1, couples to the internet 110. The network interface 112 further couples through the internet 150 to the wireless network 160 and other devices accessible over the internet 150. However, it is to be understood that the network interface 112 may, instead, directly couple to the wireless network 160 or to other of the server and terminal devices shown as accessed over the internet 110.

The network interface 112 is further configured to receive a meal request from a consumer through a consumer device 154, to provide the meal request to one or more candidate chefs for acceptance of the request, receive acceptance of the meal request from one or more candidate chefs through one or more chef devices 152 and to provide the identification of those candidate chefs that have accepted the request.

As will be understood by those having skill in the art, a network 150 may include a plurality of separate linked physical communication networks, which, using a protocol, such as the Internet protocol (IP), may appear to be a single seamless communications network to user application programs. In addition, the network interface 112 may be a plurality of different interfaces coupled to different network types including wired and wireless networks.

The chef device 152 and the consumer device 154 may be also be directly coupled to the cuisine matching server 110 rather than connected thereto over the internet 150. Similarly, the chef/consumer database 120 may be accessed by the cuisine matching server 110 over the internet 150 rather than being directly connected to the cuisine matching server 110.

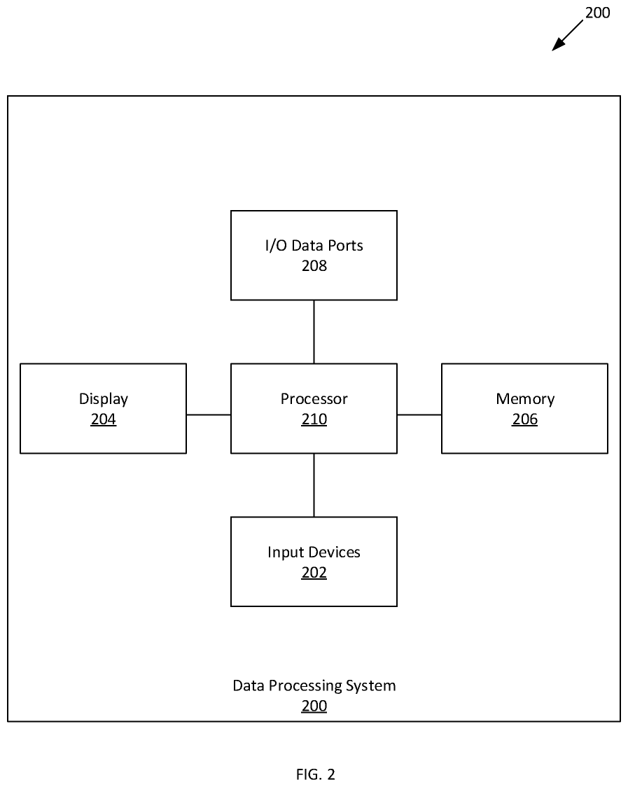

FIG. 2 illustrates an exemplary embodiment of a data processing system 200 suitable for use in accordance with embodiments of the present invention. The data processing system 200 typically includes input device(s) 202 such as a keyboard or keypad, a display 204, and a memory 206 that communicate with a processor 210. The data processing system 200 may further include an I/O data port(s) 208 that also communicate with the processor 210. The I/O data ports 208 can be used to transfer information between the data processing system 200 and another computer system or a network, such as the network 150 of FIG. 1. These components may be conventional components, such as those used in many conventional data processing systems, which may be configured to operate as described herein

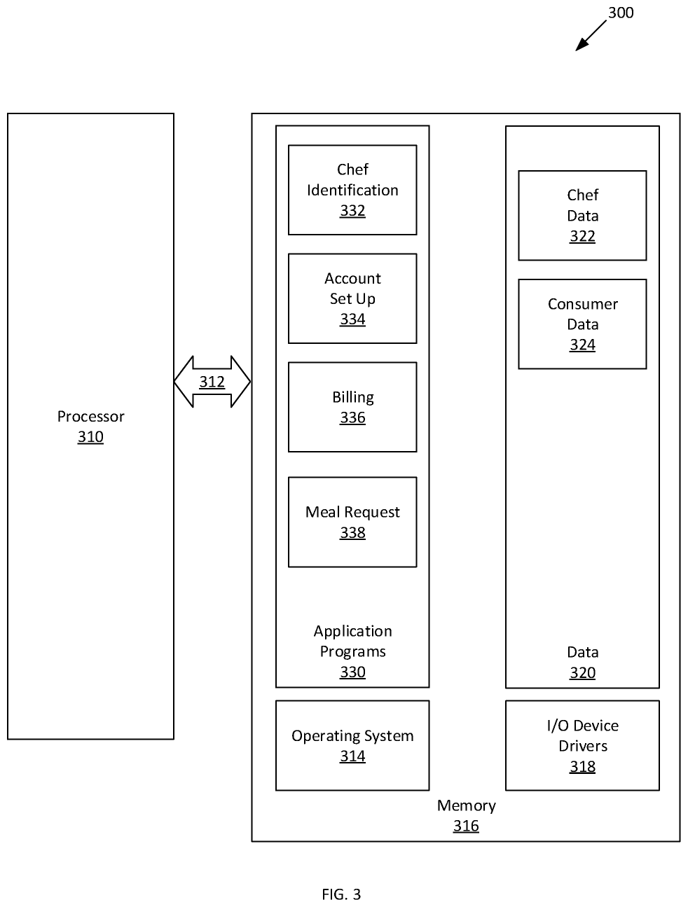

FIG. 3 is a block diagram of a data processing (computer) system that further illustrates systems, methods, and computer program products in accordance with embodiments of the present invention. The processor 310 communicates with the memory 316 via an address/data bus 312. The processor 310 can be any commercially available or custom microprocessor. The memory 316 is representative of the overall hierarchy of memory devices containing the software and data used to implement the functionality of the data processing system 300. The memory 316 can include, but is not limited to, the following types of devices: cache, ROM, PROM, EPROM, EEPROM, flash memory, SRAM, and DRAM.

As shown in FIG. 3, the memory 316 may include several categories of software and data used in the data processing system 300: the operating system 314; the application programs 330; the input/output (I/O) device drivers 318; and the data 320. As will be appreciated by those of skill in the art, the operating system 314 may be any operating system suitable for use with a data processing system, such as Solaris from Sun Microsystems, OS/2, AIX or System390 from International Business Machines Corporation, Armonk, N.Y., Windows95, Windows98, Windows NT, Windows ME, Windows XP or Windows 2000 from Microsoft Corporation, Redmond, Wash., Unix or Linux. The I/O device drivers 318 typically include software routines accessed through the operating system 314 by the application programs 230 to communicate with devices such as the I/O data port(s) 318 and certain memory 316 components. The application programs 330 are illustrative of the programs that implement the various features of the data processing system 300 and preferably include at least one application that supports operations according to embodiments of the present invention. Finally, the data 320 represents the static and dynamic data used by the application programs 330, the operating system 314, the I/O device drivers 318, and other software programs that may reside in the memory 316.

As is further seen in FIG. 3, the application programs 330 may include a chef identification module 332, an account set up module 334, a billing module 336 and a meal request module 338. The account set up module is configured to create an account for chefs and consumers. An account associated with a chef can include various chef data 322 about a chef including but not limited to the chef's name, address, cooking experience and cooking cuisine preferences. An account associated with a consumer may include consumer data 324 including but not limited to consumer's name, address and ethnic cuisine preferences.

The chef identification module 332 is configured to identify one or more chefs as candidate chef (s) based on, for example, the ethnic cuisine preference of a consumer and the level of experience of the chef(s) in preparing the specified ethnic cuisine meal.

The meal request module 338 is configured to receive a meal request from a consumer. A meal request may specify various criteria for the meal. The criteria may include, but not limited to, the date and time for the meal, the number of persons attending the meal, a preferred ethnic cuisine, a desired experience level of a potential chef and a price range by which the consumer is willing to pay for the meal. Meal request module 338 may be configured to receive such a request specific for a particular meal and/or as an initial account set up procedure for consumers in the chef/consumer database 120. Such initial registration information may include a selection of a particular ethnic cuisine, a normal preparation date and time, and a particular level of experience of a chef.

Various embodiments of the present invention further include a billing module 336 that is configured transfer payment amounts from an account of a consumer to an account of the candidate chef for an agreed meal.

The data portion 320 of memory 316, as shown in the embodiments of FIG. 3, may include various types of data, such as the chef data 322 and consumer data 324. The chef data 322 and consumer data 324, as discussed above, may include information received from the account set up module 324. Similarly, the chef data 322 and consumer data 324 may include separate accounts associated with each of the consumers and chefs and may be used by the billing module 336 in arranging payment for different meals.

While the present invention is illustrated, for example, with reference to the chef identification module 332 being an application program in FIG. 3, as will be appreciated by those of skill in the art, other configurations may also be utilized while still benefiting from the teachings of the present invention. For example, the chef identification module 332 may also be incorporated into the operating system 314 or other such logical division of the data processing system 200. Thus, the present invention should not be construed as limited to the configuration of FIG. 3 but is intended to encompass any configuration capable of carrying out the operations described herein.

Furthermore, while each of the chef identification module 332, an account set up module 334, a billing module 336 and a meal request module 338 are illustrated in a single data processing system, as will be appreciated by those of skill in the art, such functionality may be distributed across one or more data processing systems. For example, the functionality of the chef identification module 332 may be provided on one or more data processing (computer) systems that are separate from the data processing system that provides the functionality of the account setup module 334. Thus, the present invention should not be construed as limited to the configuration illustrated in FIGS. 2-3, and may be provided by other arrangements and/or division of function between data processing systems.

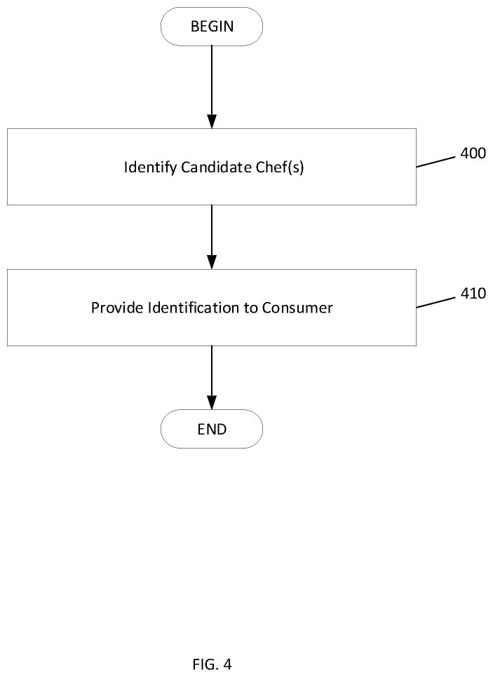

Referring now to the flowchart diagram of FIG. 4, operations for matching a consumer with a chef for a meal begin at Block 400 by identifying a candidate chef for a meal based on the various criteria. For example, the meal request from the consumer may be received over the internet 150 from the user device 154. The request may be received at the same time as the chef is needed or may be included in an initial account creation of the consumer, for example, by specifying the desire to have a meal at a particular location at a certain time on a particular day each week as part of the initial account creation.

After identification of a candidate chef, the identification of the candidate chef is provided to the consumer (Block 410). The consumer may be provided the necessary identification, for example, by establishing a voice connection and/or setting up a text messaging connection between the consumer and the candidate chef so they may negotiate a payment or other agreement for the meal.

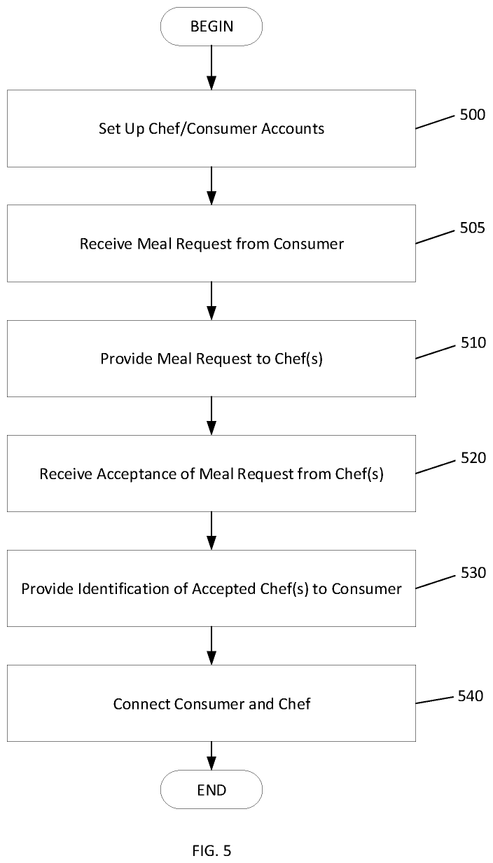

Further embodiments of the present invention are illustrated in the flow chart diagram of FIG. 5. As shown in FIG. 5, for some such embodiments, operations begin at Block 500 by account creation of a variety of chefs and consumers in the cuisine matching system.

A meal request is received from a consumer (Block 505). As discussed above, the meal request may be provided in the request received at Block 505 or may be retrieved from initial account set up information provided at Block 500.

The meal request is provided to at least one potential candidate chefs (Block 510). The potential candidates chefs are able to review the meal request to determine if there is any interest in preparing the requested meal. Upon the decision to accept the meal request, the acceptance is received from the accepting candidate chef (Block 520). The identification of the accepted candidate chef(s) are then provided to the consumer for consideration (Block 530).

More than one candidate chefs may be identified at Block 530 and a best selection may be identified first to the consumer for consideration or all of the identified candidates may be provided for consideration to allow the consumer to make a determination as to which candidate chef to contact first to arrange the meal.

After a candidate chef is identified, a communication connection is established between the consumer and the candidate chef (Block 540). The connection may be a voice connection, email and/or text messaging or other electronic communication media, which may allow the use of the cuisine matching server 110 to control privacy concerns of the individuals involved.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A system for matching a consumer with a chef, comprising:
a chef module configured to receive and store chef data;
a consumer module configured to receive and store consumer data;
a cuisine matching server configured to receive a meal request from a consumer, the meal request having meal request data,
identify a candidate chef for the meal request based on the meal request data, chef data, consumer data, and
transfer payment from a consumer account to a chef account; and
a communication network interface configured to receive the meal request from the consumer,
provide the meal request to at least one candidate chef,
receive acceptance of the meal request from at least one candidate chef, and to provide the consumer with an identification of the at least one accepted candidate chef.

2. The system of claim 1, wherein the chef data includes the chef's name, address, cooking experience and cooking cuisine preferences.

3. The system of claim 1, wherein the consumer data includes the consumer's name, address and ethnic cuisine preferences.

4. The system of claim 1, wherein the meal request data includes ethnic food preference, date of meal, time of meal, and number of people to be served.

5. The system of claim 4, wherein the meal request data further includes a price range the consumer is willing to pay for the requested meal.

6. The system of claim 5, wherein the chef data includes the chef's name, address, cooking experience, cooking cuisine preferences and a chef price range the chef is willing to accept for the preparation of meals.

7. The system of claim 1, further comprising a rating module configured to
receive and store chef performance rating data by one or more consumers, the chef performance rating data being included in the chef data; and
receive and store consumer rating data by one or more chefs, the consumer rating data being included in the consumer data.

8. A method for matching a consumer with a chef, comprising:
receiving a meal request from the consumer;
providing the meal request to at least one candidate chef;
receive an acceptance of the meal request from at least one candidate chef; and
providing the consumer with an identification of the at least one accepted candidate chef.

9. The method of claim 8, wherein the at least one candidate chef is selected based on the meal request from a consumer, chef data and consumer data.

10. The method of claim 9, wherein the chef data includes the chef's name, address, cooking experience and cooking cuisine preferences.

11. The method of claim 9, wherein the consumer data includes the consumer's name, address and ethnic cuisine preferences.

12. The method of claim 9, wherein the meal request data includes ethnic food preference, date of meal, time of meal, and number of people to be served.

13. The method of claim 12, wherein the meal request data further includes a price range the consumer is willing to pay for the requested meal.

14. The method of claim 13, wherein the chef data includes the chef's name, address, cooking experience, cooking cuisine preferences and a chef price range the chef is willing to accept for the preparation of meals.
